(19) United States
(12) Patent Application Publication
(10) Pub. No.: US 2025/0215281 A1
(43) Pub. Date: Jul. 3, 2025

(54) ADHESIVE AND PROTECTIVE FILM INCLUDING THE SAME

(71) Applicant: Samsung Display Co., LTD., Yongin-si (KR)

(72) Inventors: Dong Woon LEE, Yongin-si (KR); Nam Yun KIM, Suwon-si (KR); Dong Ho KIM, Yongin-si (KR); Byung Su KIM, Suwon-si (KR); Hyeong Seon RYU, Hwaseong-si (KR); Ju Suk OH, Yongin-si (KR); Ho Joon LEE, Hwaseong-si (KR); Sang Il HWANG, Hwaseong-si (KR)

(21) Appl. No.: 18/961,372

(22) Filed: Nov. 26, 2024

(30) Foreign Application Priority Data
Dec. 28, 2023 (KR) 10-2023-0195374

(51) Int. Cl. C09J 7/38

(52) U.S. Cl. CPC C09J 7/385; C09J 2301/414

(57) ABSTRACT

An adhesive includes: a resin binder including an acrylic polymer and carboxylic acid; metal chelate hardener; and epoxy-based hardener.

The application claims priority to Korean Patent Application No. 10-2023-0195374, filed on Dec. 28, 2023, and all the benefits accruing therefrom under 35 U.S.C. § 119, the content of which in its entirety is herein incorporated by reference.

### BACKGROUND

### Field

The disclosure relates to an adhesive and a protective film including the same.

### Description of the Related Art

As information technology develops, the importance of a display device as a connection medium between a user and information is being emphasized. Products such as a display device may include a protective film to protect the surface of a product. The protective film may be formed by applying an adhesive to a protective base member and then attaching the protective base member to the product.

In this case, because the adhesive is attached to the product, it may be difficult to remove the adhesive from the product. If the adhesive is not removed from the product, it may be difficult to remove the protective film when discarding the product. If the protective film is not removed from the product, it may be difficult to recycle the protective film.

### SUMMARY

An aspect of the disclosure is to provide an adhesive that can be more easily removed from a product and a protective film including the same.

Another aspect of the disclosure is to provide a recyclable protective film and an adhesive that has dissociability so that the protective film can be recycled.

An adhesive according to an embodiment of the disclosure includes: a resin binder including an acrylic polymer and carboxylic acid; metal chelate hardener; and epoxy-based hardener.

According to an embodiment, the carboxylic acid may be included in an amount of 10 weight percent (wt %) to 30 wt % with respect to an entire composition of the adhesive.

According to an embodiment, the carboxylic acid may be included in an amount of greater than 20 wt % and equal to or less than 30 wt % with respect to an entire composition of the adhesive.

According to an embodiment, the carboxylic acid may react with the acrylic polymer, and at least one carboxyl group of the carboxylic acid may be synthesized into the acrylic polymer.

According to an embodiment, the carboxylic acid may include acrylic acid, propylene glycol monoacrylate, and β-acryloyloxy propionic acid.

According to an embodiment, the metal chelate hardener may be included in an amount of 30 wt % to 60 wt % with respect to an entire composition of the adhesive.

According to an embodiment, the metal chelate hardener may include at least one of aluminum chelate-based hardener, titanium chelate-based hardener, or zirconium chelate-based hardener, where the aluminum chelate-based hardener may include at least one of tris ethyl acetoacetate aluminum, ethyl acetoacetate aluminum diisopropylate, tris acetylacetonate aluminum, or acetylacetonate aluminum, the titanium chelate-based hardener may include at least one of isopropoxide titanium, ethyl acetoacetate titanium, butyl acetoacetate titanium, or acetylacetonate titanium, and the zirconium chelate-based hardener may include at least one of 2-ethyl hexanoate zirconium, acetoacetate zirconium, or acetylacetonate zirconium.

According to an embodiment, the epoxy-based hardener may be included in an amount of 0.5 wt % to 2 wt % with respect to an entire composition of the adhesive.

According to an embodiment, the epoxy-based hardener may be multifunctional epoxy-based hardener.

According to an embodiment, the resin binder may have a weight average molecular weight of 8000 to 150000.

An adhesive according to another embodiment of the disclosure includes: a resin binder including an acrylic polymer and carboxylic acid; metal chelate hardener; and isocyanate-based hardener, and the carboxylic acid is included in an amount of 10 wt % to 30 wt % with respect to an entire composition of the adhesive.

According to an embodiment, the isocyanate-based hardener may be included in an amount of 0.5 wt % to 2 wt % with respect to the entire composition of the adhesive, and the isocyanate-based hardener may be multifunctional isocyanate-based hardener.

According to an embodiment, the metal chelate hardener may be included in an amount of 30 wt % to 60 wt % with respect to the entire composition of the adhesive.

A protective film according to another embodiment of the disclosure includes: a base layer and an adhesive applied on the base layer, and the adhesive includes: a resin binder including an acrylic polymer and carboxylic acid; first hardener; and second hardener.

According to an embodiment, the base layer may include at least one of polyethylene terephthalate, polyurethane, polyethylene, polyimide, polybutylene terephthalate, or polyethylene naphthalate.

According to an embodiment, the carboxylic acid may be included in an amount of 10 wt % to 30 wt % with respect to an entire composition of the adhesive.

According to an embodiment, the first hardener may be metal chelate hardener, and the metal chelate hardener may be included in an amount of 30 wt % to 60 wt % with respect to an entire composition of the adhesive.

According to an embodiment, the metal chelate hardener may include at least one of aluminum chelate-based hardener, titanium chelate-based hardener, or zirconium chelate-based hardener, where the titanium chelate-based hardener may include at least one of tris ethyl acetoacetate aluminum, ethyl acetoacetate aluminum diisopropylate, tris acetylacetonate aluminum, or acetylacetonate aluminum, the titanium chelate-based hardener may include at least one of isopropoxide titanium, ethyl acetoacetate titanium, butyl acetoacetate titanium, or acetylacetonate titanium, and the zirconium chelate-based hardener may include at least one of 2-ethyl hexanoate zirconium, acetoacetate zirconium, or acetylacetonate zirconium.

According to an embodiment, the second hardener may be multifunctional epoxy-based hardener, and the epoxy-based hardener may be included in an amount of 0.5 wt % to 2 wt % with respect to an entire composition of the adhesive.

According to an embodiment, the second hardener may be multifunctional isocyanate-based hardener, and the isocyanate-based hardener may be included in an amount of 0.5 wt % to 2 wt % with respect to an entire composition of the adhesive.

### BRIEF DESCRIPTION OF THE DRAWINGS

The accompanying drawings, which are included to provide a further understanding of the inventions, and are incorporated in and constitute a part of this specification, illustrate embodiments of the inventions, and, together with the description, serve to explain principles of the inventions.

FIG. 1 is a cross-sectional view schematically illustrating a protective film according to the disclosure.

FIG. 2 is a cross-sectional view schematically illustrating a display device provided with the protective film according to the disclosure.

### DETAILED DESCRIPTION

As the disclosure allows for various changes and numerous embodiments, particular embodiments will be illustrated in the drawings and described in detail in the written description. However, this is not intended to limit the disclosure to particular modes of practice, and it is to be appreciated that all changes, equivalents, and substitutes that do not depart from the spirit and technical scope of the disclosure are encompassed in the disclosure.

It will be understood that, although the terms “first”, “second”, etc. may be used herein to describe various elements, these elements should not be limited by these terms. These terms are only used to distinguish one element from another element. For instance, a first element discussed below could be termed a second element without departing from the scope of the disclosure. Similarly, the second element could also be termed the first element.

In the disclosure, the singular expressions are intended to include the plural expressions as well, unless the context clearly indicates otherwise. The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. Throughout the disclosure, the expression “at least one of a, b or c” indicates only a, only b, only c, both a and b, both a and c, both b and c, all of a, b, and c, or variations thereof.

It will be further understood that the terms “comprise”, “include”, “have”, etc. used in the disclosure, specify the presence of stated features, integers, steps, operations, elements, components, and/or combinations of them but do not preclude the presence or addition of one or more other features, integers, steps, operations, elements, components, and/or combinations thereof. In addition, when a first part such as a layer, film, region, plat, etc. is on a second part, the first part may be not only “directly on” the second part but a third part may intervene between them. Furthermore, in the disclosure, when a first part such as a layer, film, region, plat, etc. is formed on a second part, a direction in which the first part is formed is not limited to an upper direction of the second part, but may include a side or a lower direction of the second part. To the contrary, when a first part such as a layer, film, region, plate, etc. is “under” a second part, the first part may be not only “directly under” the second part but a third part may intervene between them.

The disclosure relates to an adhesive and a protective film including the same. The adhesive according to the disclosure may be applied to a protective film that protects the surface of a display device, etc., and may be used to attach the protective film to the display device, etc. In addition, the adhesive according to the disclosure may be used as an adhesive to attach components adjacent to the display device to each other. This will be described later with reference to the attached drawings.

The adhesive according to the disclosure may include a resin binder and hardener.

The adhesive according to the disclosure is characterized in that it can be dissociated (for example, dissociated in water) and has high reliability (for example, high durability) at high temperature (for example, temperature above 85° C.) and high humidity (for example, humidity above 85%). Each component will be described below.

The resin binder may include an acrylic polymer and carboxylic acid.

For example, the acrylic polymer may include a polymer obtained by polymerizing acrylic monomers such as ethyl acrylate, n-butyl acrylate, t-butyl acrylate, isobutyl acrylate, n-hexyl acrylate, 2-ethylhexyl acrylate, n-octyl acrylate, isooctyl acrylate, n-nonyl acrylate, isononyl acrylate, n-decyl acrylate, isodecyl acrylate, n-dodecyl acrylate, n-tridecyl acrylate, n-tetradecyl acrylate, 2(2-ethoxyethoxy) ethyl acrylate, 2-hydroxyethyl acrylate, 2-hydroxypropyl acrylate, 3-hydroxypropyl acrylate, 2-hydroxybutyl acrylate, 4-hydroxybutyl acrylate, 6-hydroxyhexyl acrylate, 8-hydroxyoctyl acrylate, 10-hydroxydecyl acrylate, 12-hydroxylauryl acrylate, and [4-(hydroxymethyl)cyclohexyl] methyl acrylate. However, the disclosure is not limited thereto, and the acrylic polymer may be one of various types of acrylic polymers known in the art.

For example, the carboxylic acid may include acetic acid, formic acid, citric acid, benzoic acid, lactic acid, maleic acid, acrylic acid, propylene glycol monoacrylate, β-acryloyloxy propionic acid, and/or the like. However, the disclosure is not limited thereto, and the carboxylic acid may be one of various types of carboxylic acids known in the art.

According to an embodiment, the acrylic polymer may be included in an amount of 8 weight percent (wt %) to 59.5 wt % with respect to an entire composition of the adhesive. However, the disclosure is not limited thereto.

According to an embodiment, the carboxylic acid may be included in an amount of 10 wt % to 30 wt % with respect to the entire composition of the adhesive. According to an embodiment, the carboxylic acid may be included in an amount of greater than 20 wt % and equal to or less than 30 wt % with respect to the entire composition of the adhesive. According to an embodiment, the carboxylic acid may be included in an amount of 21 wt % to 25 wt % with respect to the entire composition of the adhesive. According to an embodiment, the carboxylic acid may be included in an amount of 23 wt % with respect to the entire composition of the adhesive.

The carboxylic acid may react with the acrylic polymer, and at least one carboxyl group may be synthesized into an acrylic polymer chain. In the disclosure, the reaction in which the carboxyl group of the carboxylic acid is synthesized into the acrylic polymer is not limited to specific examples, and synthesis reactions known in the art can be used.

The carboxyl group may be a reactive group including an oxygen atom bonded to a hydrogen atom, and may produce hydrogen ions when it reacts with water. Therefore, the adhesive according to the disclosure may be dissociated when the adhesive reacts with water because the acrylic polymer includes the carboxyl group.

According to an embodiment, the resin binder may have a weight average molecular weight of 8000 to 150000. When the weight average molecular weight of the resin binder is less than 8000 or more than 150000, the dissociability of the adhesive may be reduced.

The hardener may include first hardener and second hardener. According to an embodiment, the first hardener may be metal chelate hardener. According to an embodiment, the second hardener may be epoxy hardener or isocyanate-based hardener.

The hardener may increase the adhesion of the adhesive. The hardener may increase the reliability of the adhesive. For example, the hardener may cure (for example, heat cure or light cure) the resin binder, increase the adhesion of the adhesive, and reduce the risk of the adhesive being damaged at high temperature and high humidity. The hardener may crosslink at least some of carboxyl groups included in the adhesive.

The metal chelate hardener may include a coordination compound of a multivalent metal. For example, the metal chelate hardener may include a coordination compound of a metal such as aluminum (Al), zirconium (Zr), and titanium (Ti). For example, the metal chelate hardener may include at least one of aluminum chelate-based hardener such as tris ethyl acetoacetate aluminum, ethyl acetoacetate aluminum diisopropylate, tris acetylacetonate aluminum, and acetylacetonate aluminum, titanium chelate-based hardener such as isopropoxide titanium, ethyl acetoacetate titanium, butyl acetoacetate titanium, and acetylacetonate titanium, or zirconium chelate-based hardener such as 2-ethyl hexanoate zirconium, acetoacetate zirconium, and acetylacetonate zirconium. However, the disclosure is not limited thereto. As long as the effect of the disclosure is not impaired, the adhesive may include various types of metal chelate-based hardeners known in the art.

The metal chelate hardener may be included in an amount of 30 wt % to 60 wt % with respect to the entire composition of the adhesive. The adhesive according to the disclosure may include 30 wt % to 60 wt % of the metal chelate hardener. Therefore, the reliability of the adhesive can be appropriately secured at high temperature and high humidity, and the dissociability of the adhesive can be properly secured.

When the metal chelate hardener is included in less than 30 wt % with respect to the entire composition of the adhesive, the adhesive may not be properly cured and the reliability of the adhesive may be reduced at high temperature and high humidity. For example, when the metal chelate hardener is included in less than 30 wt % with respect to the entire composition of the adhesive, the adhesion of the adhesive may be reduced because the carboxyl groups in the resin binder are not be properly crosslinked, and the durability of the adhesive may be reduced, such as changes in the physical properties of the adhesive at high temperature and high humidity.

When the metal chelate hardener is included in more than 60 wt % with respect to the entire composition of the adhesive, the crosslinking ratio of the carboxyl groups in the resin binder may be excessively increased, and the dissociability of the adhesive may be reduced. For example, when the metal chelate hardener is included in more than 60 wt % with respect to the entire composition of the adhesive, the carboxyl groups synthesized in the acrylic polymer may be crosslinked in an excessive amount, and the dissociability of the adhesive may be reduced.

Epoxy-based hardener may be bifunctional or higher epoxy-based hardener (i.e., multifunctional). For example, the epoxy-based hardener may include dialkylamine, tetramethylamine, polyalcohol amine, amine alcohol, or the like.

The epoxy-based hardener may be included in an amount of 0.5 wt % to 2 wt % with respect to the entire composition of the adhesive. Alternatively, according to an embodiment, the epoxy-based hardener may be included in an amount of 0.5 wt % to 1.5 wt % with respect to the entire composition of the adhesive. The adhesive according to the disclosure may include 0.5 wt % to 2 wt % of the epoxy-based hardener. Therefore, the reliability of the adhesive can be appropriately secured at high temperature and high humidity, and the dissociability of the adhesive can be properly secured.

Isocyanate-based hardener may be bifunctional or higher isocyanate-based hardener (i.e., multifunctional). For example, the isocyanate-based hardener may include one or more of xylene diisocyanate (“XDI”) including m-xylene diisocyanate and the like, methylenebis(phenyl isocyanate) (“MDI”) including 4,4′-methylenebis(phenyl isocyanate) and the like, naphthalene diisocyanate, tolylene diisocyanate, hexamethylene diisocyanate, and isophorone diisocyanate, or an adduct thereof (for example, isocyanurate form).

The isocyanate-based hardener may be included in an amount of 0.5 wt % to 2 wt % with respect to the entire composition of the adhesive. Alternatively, according to an embodiment, the isocyanate-based hardener may be included in an amount of 0.5 wt % to 1.5 wt % with respect to the entire composition of the adhesive. The adhesive according to the disclosure may include 0.5 wt % to 2 wt % of the isocyanate-based hardener. Therefore, the reliability of the adhesive can be appropriately secured at high temperature and high humidity, and the dissociability of the adhesive can be properly secured.

Then, the physical properties of the adhesive for each composition will be described below with reference to experimental results.

Table 1 below shows results of evaluating adhesion (unit: gram-force per inch (gf/in)), dissociability, and reliability at high temperature and high humidity of adhesives formed by varying a ratio of the hardener and the carboxylic acid with respect to the entire composition of the adhesive.

TABLE 1

| | | | | Reliability |
|---|---|---|---|---|
| | | | | at High |
| | Carboxylic | Adhesion | | Temperature |
| | Acid | (Unit: | | and High |
| Division | Content | gf/in) | Dissociability | Humidity |
| Comparative | 0 wt % | 3.8 | x | OF/5ea |
| Example 1 | | | | |
| Embodiment | 10 wt % | 3.9 | x | OF/5ea |
| 1 | | | | |
| Embodiment | 15 wt % | 6.2 | x | OF/5ea |
| 2 | | | | |
| Embodiment | 20 wt % | 5.6 | x | OF/5ea |
| 3 | | | | |
| Embodiment | 23 wt % | 11.8 | ∘ | 1F/5ea |
| 4 | | | | |
| Embodiment | 30 wt % | 4.2 | ∘ | 3F/5ea |
| 5 | | | | |

### Comparative Example 1

Using 2-hydroxylethyl acrylate as a functional group, ethyl acrylate, normal butyl acrylate, and 2-ethylhexyl acrylate were reacted at a temperature of 60° C. to 80° C. for 8 to 10 hours to polymerize an acrylic polymer to have a weight average molecular weight of 300,000 to 500,000, and isocyanate-based hardener was further mixed to prepare an adhesive. No metal chelate hardener was used. To prepare the adhesive, 3.2 wt % of the isocyanate-based hardener was used with respect to the entire composition of the adhesive. As the isocyanate-based hardener, hexamethylene diisocyanate was used.

The adhesive of Comparative Example 1 does not include carboxylic acid and does not include metal chelate hardener.

### Embodiment 1

Compared to Comparative Example 1, epoxy-based hardener was used instead of the isocyanate-based hardener, and carboxylic acid and metal chelate hardener were further used. Tetramethylamine was used as the epoxy-based hardener, and 1 wt % of the epoxy-based hardener was used with respect to the entire composition of the adhesive. Acrylic acid, propylene glycol monoacrylate, and β-acryloyloxy propionic acid were mixed in equal amounts (wt %) so that 10 wt % of carboxylic acid was included with respect to the entire composition of the adhesive. Acetylacetonate aluminum was used as the metal chelate hardener, and was used in an amount of 50 wt % with respect to the entire composition of the adhesive.

### Embodiment 2

An adhesive was prepared by including the same materials as in Embodiment 1 and mixing equal amounts (wt %) of acrylic acid, propylene glycol monoacrylate, and β-acryloyloxy propionic acid so that 15 wt % of carboxylic acid was included with respect to the entire composition of the adhesive.

### Embodiment 3

An adhesive was prepared by including the same materials as in Embodiment 1 and mixing equal amounts (wt %) of acrylic acid, propylene glycol monoacrylate, and β-acryloyloxy propionic acid so that 20 wt % of carboxylic acid was included with respect to the entire composition of the adhesive.

### Embodiment 4

An adhesive was prepared by including the same materials as in Embodiment 1 and mixing equal amounts (wt %) of acrylic acid, propylene glycol monoacrylate, and β-acryloyloxy propionic acid so that 23 wt % of carboxylic acid was included with respect to the entire composition of the adhesive.

### Embodiment 5

An adhesive was prepared by including the same materials as in Embodiment 1 and mixing equal amounts (wt %) of acrylic acid, propylene glycol monoacrylate, and β-acryloyloxy propionic acid so that 30 wt % of carboxylic acid was included with respect to the entire composition of the adhesive.

In Comparative Example 1, Embodiment 1, Embodiment 2, Embodiment 3, Embodiment 4, and Embodiment 5, the adhesive was coated on a film (here, the film is an adherend to which the adhesive is applied) to have a thickness of 5 micrometers (μm) to 20 μm.

As an experimental method to evaluate adhesion, an adhesion evaluation method according to the ‘ASTM D3330 Peel Adhesion Pressure Sensitive Adhesive Tapes’ test method was used.

Referring to Table 1 above, it can be seen that the adhesion is higher in Embodiments 1 to 5 than in Comparative Example 1. Compared to Comparative Example 1, Embodiments 1 to 5 may further include the metal chelate hardener and may have higher adhesion.

In the dissociation evaluation, an experimental subject was immersed in a 0.5 wt % sodium hydroxide aqueous solution, gently boiled at a temperature of 55° C., and stirred at 1500 revolutions per minute (rpm) for 30 minutes. Referring to the dissociation evaluation in Table 1, the surface tacky was evaluated according to the eco-label certification standard EL103 dissociation evaluation standard. If it did not meet the standard, it was recorded as “x”, and if it met the standard, it was recorded as “o”.

Referring to Table 1 above, it can be confirmed that Embodiments 4 and 5 satisfy the eco-label certification standard EL103 dissociation evaluation standard. The remaining embodiments did not satisfy the eco-label certification standard EL103 dissociation evaluation standard. However, for the remaining embodiments, it was measured whether the adhesive remained on the film, and it was confirmed that a portion of the adhesive had been removed from the film. Whether the adhesive remained on the film can be confirmed by measuring the weight of the film before and after immersion in the 0.5 wt % sodium hydroxide aqueous solution and measuring whether the surface is sticky.

The evaluation of reliability at high temperature and high humidity was conducted under conditions of a temperature of 85° C. and humidity of 85%. After the film was left for 72 hours, it was measured whether any stains occurred on the film. In this case, in Table 1, “ea” refers to the number of experimental subjects evaluated, and “F” refers to the number of experimental subjects in which stains occurred. For example, “3F/5ea” means that stains occurred on three protective films out of five experimental subjects.

Referring to the experimental results of Embodiments 1 to 4 in Table 1 above, it can be confirmed that Embodiments 1 to 4 have high reliability at high temperature and high humidity. Embodiment 5 has lower reliability at high temperature and high humidity than Embodiment 3, but it can be confirmed that it has excellent dissociability according to the eco-label certification standard EL103 dissociation evaluation standard.

Table 2 below shows results of evaluating adhesion, dissociability, and reliability at high temperature and high humidity of adhesives formed by varying whether or not the hardener is included and a ratio (wt %) of the hardener with respect to the entire composition of the adhesive.

TABLE 2

| | | | | | | Re- |
|---|---|---|---|---|---|---|
| | | | | | | liability |
| | | | | | | at High |
| | | | | Ad- | | Temper- |
| | Carboxylic | First | Second | hesion | Dis- | ature |
| | Acid | Hardener | Hardener | (Unit: | socia- | and High |
| Division | Content | Content | Content | gf/in) | bility | Humidity |
| Compar- | 30 wt % | 50 wt % | 0 wt % | 15.2 | ○ | 5F/5ea |
| ative | | | | | | |
| Example | | | | | | |
| 2 | | | | | | |
| Compar- | 23 wt % | 50 wt % | 0 wt % | 14.7 | ○ | 3F/5ea |
| ative | | | | | | |
| Example | | | | | | |
| 3 | | | | | | |
| Embod- | 23 wt % | 50 wt % | 0.5 wt % | 18.2 | ○ | 3F/5ea |
| iment 6 | | | | | | |
| Embod- | 23 wt % | 50 wt % | 1.0 wt % | 19.1 | ○ | 1F/5ea |
| iment 7 | | | | | | |
| Embod- | 23 wt % | 50 wt % | 0.5 wt % | 16.7 | ○ | 1F/5ea |
| iment 8 | | | | | | |
| Embod- | 23 wt % | 50 wt % | 1.0 wt % | 15.5 | ○ | OF/5ea |
| iment 9 | | | | | | |
| Embod- | 23 wt % | 50 wt % | 1.5 wt % | 13.9 | ○ | OF/5ea |
| iment 10 | | | | | | |
| Embod- | 23 wt % | 50 wt % | 2.0 wt % | 12.6 | x | OF/5ea |
| iment 11 | | | | | | |

### Comparative Example 2

Using 2-hydroxylethyl acrylate as a functional group, ethyl acrylate, normal butyl acrylate, and 2-ethylhexyl acrylate were reacted at a temperature of 60° C. to 80° C. for 8 to 10 hours to polymerize an acrylic polymer to have a weight average molecular weight of 300,000 to 500,000, and carboxylic acid and first hardener was further used to prepare an adhesive. Acrylic acid, propylene glycol monoacrylate, and β-acryloyloxy propionic acid were used as the carboxylic acid. The acrylic acid, propylene glycol monoacrylate, and β-acryloyloxy propionic acid were mixed in equal amounts (wt %) so that 30 wt % of carboxylic acid was included with respect to the entire composition of the adhesive. The first hardener was metal chelate hardener, and acetylacetonate aluminum was used, and was used in an amount of 50 wt % with respect to the entire composition of the adhesive.

### Comparative Example 3

Compared to Comparative Example 2, the same materials were included, but 23 wt % of carboxylic acid was used with respect to the entire composition of the adhesive. Acrylic acid, propylene glycol monoacrylate, and β-acryloyloxy propionic acid were mixed in equal amounts (wt %).

### Embodiment 6

Compared to Comparative Example 3, the same materials were included, but the second hardener was further used. The second hardener was isocyanate-based hardener, and hexamethylene diisocyanate was used, and was used in an amount of 0.5 wt % with respect to the entire composition of the adhesive. Acrylic acid, propylene glycol monoacrylate, and β-acryloyloxy propionic acid were mixed in equal amounts (wt %).

### Embodiment 7

Compared to Comparative Example 3, the same materials were included, but the second hardener was further used. The second hardener was isocyanate-based hardener, and hexamethylene diisocyanate was used, and was used in an amount of 1.0 wt % with respect to the entire composition of the adhesive. Acrylic acid, propylene glycol monoacrylate, and β-acryloyloxy propionic acid were mixed in equal amounts (wt %).

### Embodiment 8

Compared to Comparative Example 3, the same materials were included, but the second hardener was further used. The second hardener was epoxy-based hardener, and tetramethylamine was used, and was used in an amount of 0.5 wt % with respect to the entire composition of the adhesive. Acrylic acid, propylene glycol monoacrylate, and β-acryloyloxy propionic acid were mixed in equal amounts (wt %).

### Embodiment 9

Compared to Comparative Example 3, the same materials were included, but the second hardener was further used. The second hardener was epoxy-based hardener, and tetramethylamine was used, and was used in an amount of 1.0 wt % with respect to the entire composition of the adhesive. Acrylic acid, propylene glycol monoacrylate, and β-acryloyloxy propionic acid were mixed in equal amounts (wt %).

### Embodiment 10

Compared to Comparative Example 3, the same materials were included, but the second hardener was further used. The second hardener was epoxy-based hardener, and tetramethylamine was used, and was used in an amount of 1.5 wt % with respect to the entire composition of the adhesive. Acrylic acid, propylene glycol monoacrylate, and β-acryloyloxy propionic acid were mixed in equal amounts (wt %).

### Embodiment 11

Compared to Comparative Example 3, the same materials were included, but the second hardener was further used. The second hardener was epoxy-based hardener, and tetramethylamine was used, and was used in an amount of 2.0 wt % with respect to the entire composition of the adhesive. Acrylic acid, propylene glycol monoacrylate, and β-acryloyloxy propionic acid were mixed in equal amounts (wt %).

The evaluation of adhesion, dissocibility, and reliability at high temperature and high humidity was conducted in the same manner as the experimental method disclosed in Table 1.

First, looking at the experimental results of Comparative Example 2, it can be confirmed that Comparative Example 2 has appropriate adhesion in the adhesion evaluation and satisfies the eco-label certification standard EL103 dissociation evaluation standard in the dissociation evaluation. However, Comparative Example 2 did not include the second hardener (isocyanate-based hardener or epoxy-based hardener), so it can be confirmed that stains occurred in all five experimental subjects in the evaluation of the reliability at high temperature and high humidity.

Looking at the experimental results of Comparative Example 3, it can be confirmed that Comparative Example 3 has appropriate adhesion in the adhesion evaluation and satisfies the eco-label certification standard EL103 dissociation evaluation standard in the dissociation evaluation. However, Comparative Example 3 did not include the second hardener (isocyanate-based hardener or epoxy-based hardener), so it can be confirmed that stains occurred in all three experimental subjects in the evaluation of the reliability at high temperature and high humidity.

Comparing Embodiment 6 and Comparative Example 3, it can be confirmed that the adhesion has increased. Since Embodiment 6 includes isocyanate-based hardener, the adhesive can be cured more firmly than in Comparative Example 3, and the adhesion of the adhesive can be increased.

Comparing Embodiment 7 and Comparative Example 3, it can be confirmed that the adhesion has increased. Since Embodiment 7 includes isocyanate-based hardener, the adhesive can be cured more firmly than in Comparative Example 3, and the adhesion of the adhesive can be increased.

In addition, comparing Embodiment 7 and Comparative Example 3, it can be confirmed that the reliability at high temperature and high humidity has increased.

Comparing Embodiment 8 and Comparative Example 3, it can be confirmed that the adhesion has increased. Since Embodiment 8 includes epoxy-based hardener, the adhesive can be cured more firmly than in Comparative Example 3, and the adhesion of the adhesive can be increased.

In addition, comparing Embodiment 8 and Comparative Example 3, it can be confirmed that reliability at high temperature and high humidity has increased.

Comparing Embodiment 9 and Comparative Example 3, it can be confirmed that the adhesion has increased. Since Embodiment 9 includes epoxy-based hardener, the adhesive can be cured more firmly than in Comparative Example 3, and the adhesion of the adhesive can be increased.

In addition, comparing Embodiment 9 and Comparative Example 3, it can be confirmed that the reliability at high temperature and high humidity has increased. Looking at the results of evaluating the reliability at high temperature and high humidity in Embodiment 9, it can be confirmed that no stains occurred in all five experimental subjects.

Comparing Embodiment 10 and Comparative Example 3, it can be confirmed that the reliability at high temperature and high humidity has increased. Embodiment 10 has lower adhesion than Comparative Example 3, but looking at the results of evaluating the reliability at high temperature and high humidity in Embodiment 10, it can be confirmed that no stains occurred in all five experimental subjects.

Comparing Embodiment 11 and Comparative Example 3, it can be confirmed that the reliability at high temperature and high humidity has increased. Looking at the results of evaluating the reliability at high temperature and high humidity in Embodiment 11, it can be confirmed that no stains occurred in all five experimental subjects.

Embodiment 11 did not satisfy the eco-label certification standard EL103 dissociation evaluation standard. However, it was measured whether the adhesive remained on the film, and it was confirmed that a portion of the adhesive had been removed from the film.

The adhesive according to the disclosure may include 10 wt % to 30 wt % of carboxylic acid with respect to the entire composition of the adhesive, and at least a portion of the adhesive may be dissociated when reacting with water. In addition, the adhesive according to the disclosure may include 30 wt % to 60 wt % of metal chelate hardener and 0.5 wt % to 2 wt % of epoxy-based hardener or isocyanate-based hardener with respect to the entire composition of the adhesive. Therefore, the reliability of the adhesive can be appropriately secured at high temperature and high humidity, and the dissociability and adhesion of the adhesive can be properly secured.

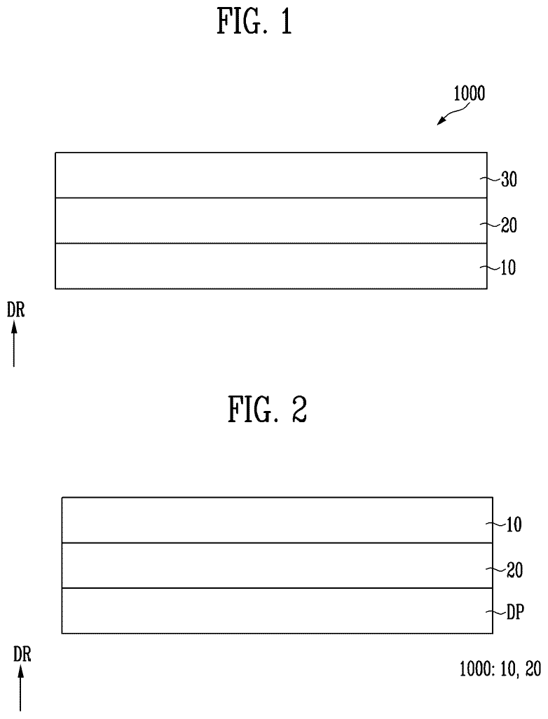

Hereinafter, with reference to FIG. 1, a protective film according to the disclosure will be described. FIG. 1 is a cross-sectional view schematically illustrating the protective film according to the disclosure.

A protective film 1000 may include a base layer 10 and an adhesive layer 20.

The base layer 10 may include an organic material. According to an embodiment, the base layer 10 may include at least one of polyethylene terephthalate, polyurethane, polyethylene, polyimide, polybutylene terephthalate, or polyethylene naphthalate. According to an embodiment, the base layer 10 may include an ester-based polymer, a cyclic olefin-based polymer (“COP”), a carbonate-based polymer, or a copolymer of these materials. However, the disclosure is not limited thereto, and the base layer may include various types of known organic materials.

The base layer 10 may have high transparency. In addition, the base layer 10 may have excellent mechanical strength and dimensional change after heat treatment.

The adhesive layer 20 may be disposed on the base layer 10. The adhesive layer 20 may be disposed on the base layer 10 based on a stacking direction DR.

The adhesive layer 20 may include the adhesive described above. The adhesive layer 20 may be formed by applying (or coating) the adhesive described above.

When the base layer 10 includes an organic material (for example, polyethylene terephthalate), if the adhesive does not have dissociability, the adhesive layer 20 coated on the base layer 10 may be difficult to remove. In order for the organic material such as polyethylene terephthalate to be recycled, the protective film 1000 must be pulverized and provided to an extrusion molding machine, and provided in the form of pellets. In this case, if the adhesive layer 20 is not removed from the base layer 10, the protective film 1000 may become entangled with each other in the extrusion molding machine, making it difficult for the base layer 10 to be provided in the form of pellets.

According to the disclosure, since the adhesive layer 20 of the protective film 1000 includes the adhesive having dissociability, the adhesive layer 20 can be easily removed from the base layer 10. In addition, since the base layer 10 of the protective film 1000 can be provided to the extrusion molding machine in the form of pellets, the organic material such as polyethylene terephthalate can be recycled.

According to an embodiment, the protective film 1000 may further include a release layer 30 disposed on the adhesive layer 20.

The release layer 30 may protect the adhesive layer 20. The release layer 30 may be removed when the protective film 1000 is attached to a display device DD (see FIG. 2) or the like.

The release layer 30 may be composed of a base member and a layer disposed on the base member and coated with a release agent. The release agent may be epoxy-based, epoxy-melamine-based, amino alkyd-based, acrylic-based, melamine-based, silicone-based, fluorine-based, cellulose-based, urea resin-based, polyolefin-based, or paraffin-based material. However, the disclosure is not limited thereto, and the release agent may be any release agent material available in the art.

Hereinafter, the display device DD on which the protective film according to the disclosure is disposed will be described with reference to FIG. 2. FIG. 2 is a cross-sectional view schematically illustrating a display device provided with the protective film according to the disclosure.

Referring to FIG. 2, the display device DD according to the disclosure may include a display panel DP and the protective film 1000.

The display panel DP may be an organic electroluminescent display panel, a liquid crystal display panel, a plasma display panel, an electrophoretic display panel, a microelectromechanical system (“MEMS”) display panel, an electrowetting display panel, or the like.

The protective film 1000 may be disposed on the display panel DP. The release layer 30 of the protective film 1000 may be removed when attached to the display panel DP, and the adhesive layer 20 may be in contact with the display panel DP. However, the disclosure is not limited thereto.

According to an embodiment, the display device DD may further include general components known in the art, such as a touch sensing unit and a polarizing member, which are disposed between the display panel DP and the protective film 1000.

According to the embodiments of the disclosure, an adhesive that can be more easily removed from a product and a protective film including the same can be provided, and the protective film can be recycled.

As described above, the optimal embodiments of the disclosure have been disclosed through the detailed description and the drawings. However, those skilled in the art or those of ordinary skill in the art will appreciate that various modifications and changes are possible without departing from the spirit and technical scope of the disclosure as set forth in the claims below.

Therefore, the technical protection scope of the disclosure is not limited to the detailed description described in the specification, but should be determined by the appended claims.

What is claimed is:

1. An adhesive comprising:
a resin binder including an acrylic polymer and carboxylic acid;
metal chelate hardener; and
epoxy-based hardener.

2. The adhesive of claim 1, wherein the carboxylic acid is included in an amount of 10 weight percent (wt %) to 30 wt % with respect to an entire composition of the adhesive.

3. The adhesive of claim 1, wherein the carboxylic acid is included in an amount of greater than 20 wt % and equal to or less than 30 wt % with respect to an entire composition of the adhesive.

4. The adhesive of claim 1, wherein the carboxylic acid reacts with the acrylic polymer, and at least one carboxyl group of the carboxylic acid is synthesized into the acrylic polymer.

5. The adhesive of claim 1, wherein the carboxylic acid includes acrylic acid, propylene glycol monoacrylate, and β-acryloyloxy propionic acid.

6. The adhesive of claim 1, wherein the metal chelate hardener is included in an amount of 30 wt % to 60 wt % with respect to an entire composition of the adhesive.

7. The adhesive of claim 1, wherein the metal chelate hardener includes at least one of aluminum chelate-based hardener, titanium chelate-based hardener, or zirconium chelate-based hardener,
wherein the aluminum chelate-based hardener includes at least one of tris ethyl acetoacetate aluminum, ethyl acetoacetate aluminum diisopropylate, tris acetylacetonate aluminum, or acetylacetonate aluminum,
the titanium chelate-based hardener includes at least one of isopropoxide titanium, ethyl acetoacetate titanium, butyl acetoacetate titanium, or acetylacetonate titanium, and
the zirconium chelate-based hardener includes at least one of 2-ethyl hexanoate zirconium, acetoacetate zirconium, or acetylacetonate zirconium.

8. The adhesive of claim 1, wherein the epoxy-based hardener is included in an amount of 0.5 wt % to 2 wt % with respect to an entire composition of the adhesive.

9. The adhesive of claim 1, wherein the epoxy-based hardener is multifunctional epoxy-based hardener.

10. The adhesive of claim 1, wherein the resin binder has a weight average molecular weight of 8000 to 150000.

11. An adhesive comprising:
a resin binder including an acrylic polymer and carboxylic acid;
metal chelate hardener; and
isocyanate-based hardener,
wherein the carboxylic acid is included in an amount of 10 wt % to 30 wt % with respect to an entire composition of the adhesive.

12. The adhesive of claim 11, wherein the isocyanate-based hardener is included in an amount of 0.5 wt % to 2 wt % with respect to the entire composition of the adhesive, and
wherein the isocyanate-based hardener is multifunctional isocyanate-based hardener.

13. The adhesive of claim 11, wherein the metal chelate hardener is included in an amount of 30 wt % to 60 wt % with respect to the entire composition of the adhesive.

14. A protective film comprising:
a base layer and an adhesive applied on the base layer,
wherein the adhesive includes:
a resin binder including an acrylic polymer and carboxylic acid;
first hardener; and
second hardener.

15. The protective film of claim 14, wherein the base layer includes at least one of polyethylene terephthalate, polyurethane, polyethylene, polyimide, polybutylene terephthalate, or polyethylene naphthalate.

16. The protective film of claim 14, wherein the carboxylic acid is included in an amount of 10 wt % to 30 wt % with respect to an entire composition of the adhesive.

17. The protective film of claim 14, wherein the first hardener is metal chelate hardener, and
wherein the metal chelate hardener is included in an amount of 30 wt % to 60 wt % with respect to an entire composition of the adhesive.

18. The protective film of claim 17, wherein the metal chelate hardener includes at least one of aluminum chelate-based hardener, titanium chelate-based hardener, or zirconium chelate-based hardener,
wherein the chelate-based hardener includes at least one of tris ethyl acetoacetate aluminum, ethyl acetoacetate aluminum diisopropylate, tris acetylacetonate aluminum, or acetylacetonate aluminum,
the titanium chelate-based hardener includes at least one of isopropoxide titanium, ethyl acetoacetate titanium, butyl acetoacetate titanium, or acetylacetonate titanium, and
the zirconium chelate-based hardener includes at least one of 2-ethyl hexanoate zirconium, acetoacetate zirconium, or acetylacetonate zirconium.

19. The protective film of claim 14, wherein the second hardener is multifunctional epoxy-based hardener, and
wherein the epoxy-based hardener is included in an amount of 0.5 wt % to 2 wt % with respect to an entire composition of the adhesive.

20. The protective film of claim 14, wherein the second hardener is multifunctional isocyanate-based hardener, and
wherein the isocyanate-based hardener is included in an amount of 0.5 wt % to 2 wt % with respect to an entire composition of the adhesive.
